(19) United States
(12) Patent Application Publication
(10) Pub. No.: US 2008/0166233 A1
(43) Pub. Date: Jul. 10, 2008

(54) Turbine component with repaired seal land and related method

(75) Inventors: Jere A. Johnson, Greenville, SC (US); John Zelahy, Orlando, FL (US); Ron Souther, Campobello, SC (US); Warren Miglietti, Greenville, SC (US); James C. Monaghan, Moore, SC (US)

Correspondence Address: NIXON & VANDERHYE, PC, 901 NORTH GLEBE ROAD, 11TH FLOOR, ARLINGTON, VA, 22203, US

(73) Assignee: General Electric Company, Schenectady, NY (US)

(21) Appl. No.: 11/651,070

(22) Filed: Jan. 9, 2007

(51) Int. Cl. B23P 6/00; B23K 31/02; F01D 25/00; F16J 15/02; F01D 11/00

(52) U.S. Cl. 415/230; 29/402.02; 228/119; 277/650

(57) ABSTRACT

A method of repairing a turbine component seal land includes: (a) removing material along substantially the entire seal land to provide a preform-receiving face; (b) locating a repair preform along and engaged with said preform-receiving face; (c) brazing the preform to said preform-receiving face; (d) and finish machining an exposed face of the preform to specifications, thereby providing a repaired seal land.

### BACKGROUND OF THE INVENTION

This invention relates to turbine component repair methods generally, and, more specifically, to the repair of seal land surfaces in turbine components.

Nimonic® aft transition pieces, extending between gas turbine combustors and first stage nozzles, sustain considerable wear from the seals between the transition piece aft frame and the first stage nozzle. Typically, the inner and outer seal lands require weld repair in order to restore the aft frames to acceptable geometry for the component to be returned to service. This has led to a requirement to develop a process that provides a more efficient cycle than conventional weld repair, as well as a repaired seal land that is more wear resistant.

### BRIEF SUMMARY

The exemplary but non-limiting embodiment described herein provides a method of repairing worn transition piece seal lands that includes machining or otherwise removing material from the worn seal land surface and brazing a clad alloy preform onto the machined surface. The preform substrate comprises a superalloy mixture as further described herein. The exposed surface of the preform is then clad with a suitable cobalt-based alloy. After brazing, the clad surface is machined to final specifications. This repair approach is more efficient and less expensive then weld repair, avoids the distortion that the weld repair introduces, and enhances the seal land area wear characteristics.

Accordingly, in one aspect the present invention relates to a method of repairing a turbine component seal land comprising: (a) removing material along substantially the entire seal land to provide a preform-receiving face; (b) locating a repair preform along and engaged with said preform-receiving face; (c) brazing the preform to said preform-receiving face; and (d) finish machining an exposed face of the preform to specifications, thereby providing a repaired seal land.

In another aspect, the invention relates to a method of repairing a seal land at a downstream or outlet end of a gas turbine transition piece extending between a combustor and a first stage nozzle, the seal land formed by one side wall of a U-shaped channel, the method comprising: (a) removing material along substantially the entire seal land to provide a preform-receiving face; (b) locating a repair preform along and engaged with said preform-receiving face; (c) brazing the preform to said preform-receiving face; and (d) finish machining an exposed face of the preform to specifications, thereby providing a repaired seal land within said U-shaped channel.

In still another aspect, the invention relates to a gas turbine component comprising an end configuration with a seal land adapted to be engaged by a seal element; said seal land comprised of a clad preform brazed to the component.

The invention will be described in detail in connection with the drawings identified below.

### BRIEF DESCRIPTION OF THE DRAWINGS

FIG. 1 is a schematic side elevation, partly in section, of a transition piece, illustrating the aft frame seal land areas;

FIG. 2 is an enlarged detail of the inner seal land taken from FIG. 1;

FIG. 3 is a section view illustrating an outer seal land and seal engaged with the seal land;

FIGS. 4-6 are section views illustrating, in sequence, the repair method in accordance with the exemplary embodiment;

FIG. 7 is a front elevation of an outer seal land repair preform; and

FIG. 8 is a section taken along the line 9-9 of FIG. 7.

### DETAILED DESCRIPTION OF THE DRAWINGS

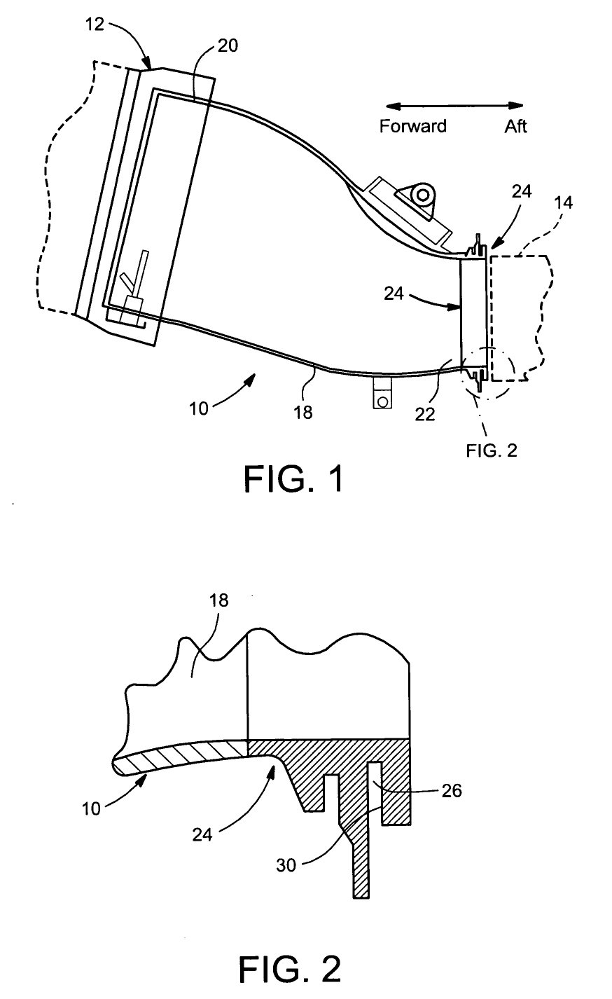

Referring now to the drawings, particularly to FIGS. 1 and 2, there is illustrated a transition piece, generally designated 10, for enclosing and confining combustion products for flow from a combustor 12 of a gas turbine to a first stage nozzle assembly 14. It will be appreciated that there is an annular array of combustors for generating and flowing hot gases to the first stage nozzle assembly 14, one each of such combustors 12 and transition pieces 10 illustrated in FIG. 1.

AS illustrated, the transition piece 10 includes a body or enclosure 18 that includes an inlet end 20 and an outlet end 22 for respectively receiving the combustion gases and flowing the gases into the nozzle assembly 14. The inlet end 20 of the transition piece 10 is generally circular, but the transition piece body 18 transitions from the circular inlet end generally axially and radially inwardly relative to the turbine axis and terminates in the slightly arcuate, generally rectilinear outlet end 22 adjacent the first stage nozzle assembly (or simply “nozzle”) 14.

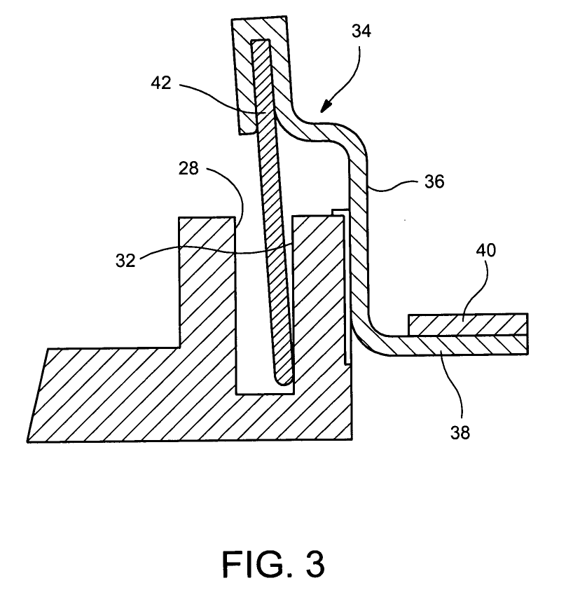

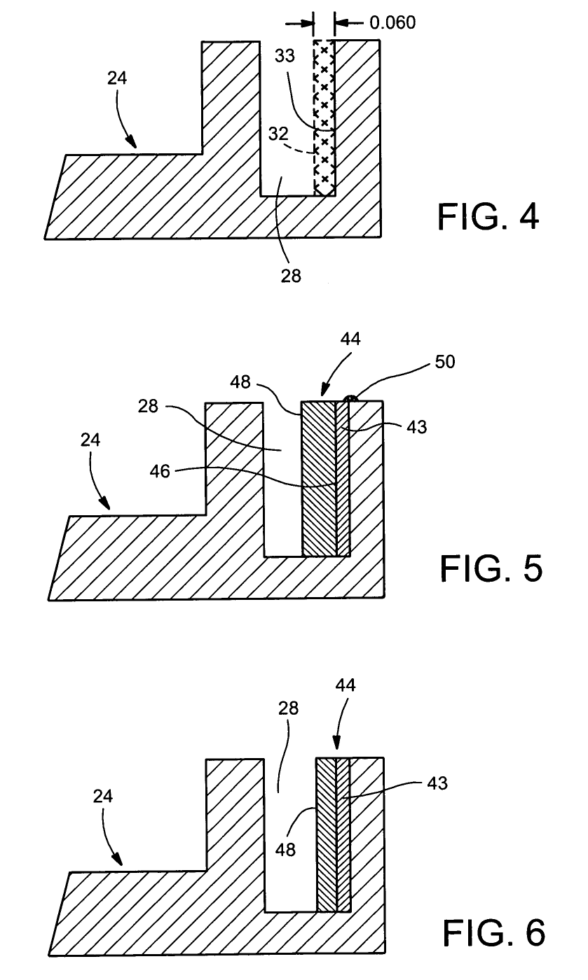

The outlet or aft end 22 incorporates a frame 24 that includes an inner seal receiving channel 26 (FIG. 2) and an outer seal receiving channel 28. The seal land in the inner channel 26 is shown at 30 in FIG. 2, and the seal land on the outer channel 28 is shown at 32 in FIG. 3. While the inner and outer frame configurations are not identical, the seal land repair process described herein is identical for both, and the process will be therefore be described only with respect to the outer seal land 32 shown in FIG. 4.

FIG. 3 also illustrates a known seal arrangement 34 where a seal holder or bracket 36 is secured at one end 38 to a support component 40 fixed to the first stage nozzle 14. The seal holder 36 mounts a cloth seal 42 such that the seal is received in the channel 28. The seal 42 is oriented to engage the surface or seal land 32 on one side of the channel. It will be appreciated that this surface is subject to wear as a result of the constant movement and vibration of the transition piece 10 during turbine operation relative to the first stage nozzle 14, and as the seal 42 moves back and forth along the land 32.

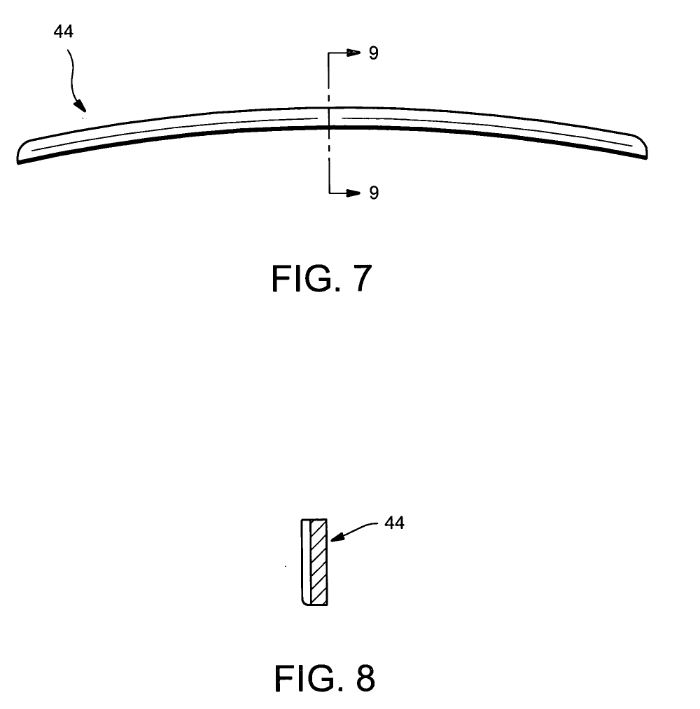

At such time as the land 32 requires repair due to excessive wear, the following repair process, described below in connection with FIGS. 4-6, has been found to be effective. First, the land surface 32 is pre-machined to remove material along the seal land, to the full depth of the channel 28. In one non-limiting example, 0.060″ is removed from the land 32 as shown in FIG. 4. The channel 28 (or the entire frame 24, especially if the inner seal land 30 is repaired at the same time) is then steam cleaned and dried, and the channel is then additionally cleaned with, for example, acetone or other appropriate chemical (it is important that the chosen chemical not interfere with the braze repair). A repair preform 44 is then located within the channel and shimmed in place. The preform 44, best seen in FIGS. 7 and 8, is curved over its length to conform to the shape of the slot or channel 28 in the radially outer side of the transition piece aft frame 24. The preform substrate or base 43 may be composed of a suitable alloy material, and preferably a mixture of any one of Nimonic® 263, Haynes 230, Inconel 617, Hastelloy X or other suitable superalloy, with a suitable braze powder such as BNi-9 (a commercial embodiment of which is Amdry 775), or AMS 4776 to 4779. The ratio of the two may be in the range of 20/80 to 80/20, respectively, with a 60/40 ratio preferred. In the exemplary embodiment, the exposed face 46 of the preform substrate 43 may be clad with L605 (see cladding 48 in FIGS. 5 and 6), Haynes 188 or other suitable cobalt-based alloy. The L605 alloy may be preferred in some instances where both the cloth seal and transition piece aft frame are constructed of the same material. Thus, the preform 44 is composed of the base or substrate 43 and the cladding 48. Alternatively, the preform 44 could be supplied in tape form, comprised of a mixture of braze powder and superalloy powder or pure braze powder, where the powder will be suspended in a binder. There are many commercial binders available, but those containing polytetrafluoroethylene (such as Teflon®) are the most desirable. Accordingly, for purposes of this disclosure, the term “preform” is intended to include the relatively rigid component shown in FIGS. 7 and 8, as well as a flexible braze tape, where the braze tape can be a stand-alone braze filler or mixed with a superalloy powder.

In the exemplary embodiment, the preform 44 may have an overall thickness of 0.097″ including, for example, 0.062″ L605 and 0.035″ Nimonic® 263/Amdry 775. In an alternative embodiment, the preform 44 may be an overall thickness of 0.097″ including, for example, 0.084″-0.095″ L605 and correspondingly 0.002″ BNi9 braze tape.

In still another embodiment, the preform 44 may have an overall thickness of 0.097″ including, for example, 0.062″ L605 and 0.035″ Nimonic® 263/Amdry 775 braze tape.

After the preform 44 is located in the channel 28 and shimmed to hold it in place against the machined seal land surface (or preform-receiving face) 33, a bead 50 of braze paste may be applied along the outer edge of the preform as shown in FIG. 5. The braze paste may be any suitable commercially available braze paste, with no superalloy powder added, or it may be a mixture of braze paste and superalloy powder. Thereafter, the transition piece and aft frame are placed in a furnace. The preferred process is vacuum brazing, although partial pressure brazing with Argon, Helium or other appropriate gas environments are also possible.

An exemplary process includes the following steps:

(1) Pump-down to achieve a vacuum level of 10-3 torr or better;

(2) Ramp up to 1800° F.±50° F. at a minimum rate of 10° F./min;

(3) Hold at 1800° F.±50° F. for 30 minutes±15 minutes;

(4) Ramp up to 2125° F.±25° F. at a minimum rate of 10° F./min;

(5) Hold at 2125° F.±25° F. for 30 minutes±15 minutes;

(6) Furnace cool to 1975° F.±150° F. under vacuum;

(7) Quench to 250° F. with argon or helium gas; and

(8) remove component at a safe temp, e.g., 150° F.

The exposed face of the cladding 48 is subsequently machined to specifications to provide the appropriate channel width for the seal, as illustrated in FIG. 6.

It will be appreciated that the various dimensions and material compositions may vary with specific applications. In addition, the repair process described herein is not limited to any particular seal type or compositions.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of repairing a turbine component seal land comprising:
(a) removing material along substantially the entire seal land to provide a preform-receiving face;
(b) locating a repair preform along and engaged with said preform-receiving face;
(c) brazing the preform to said preform-receiving face; and
(d) finish machining an exposed face of the preform to specifications, thereby providing a repaired seal land.

2. The method of claim 1 wherein said turbine component comprises a gas turbine transition piece, with said seal land located at an outlet end of said transition piece.

3. The method of claim 2 wherein said seal land extends along a radially outer edge of said outlet end.

4. The method of claim 2 wherein said seal land extends along a radially inner edge of said outlet end.

5. The method of claim 1 wherein said seal land comprises one side of a substantially U-shaped channel.

6. The method of claim 1 wherein said repair preform comprises a mixture of a first nickel-chromium-cobalt alloy and a second nickel-chromium-boron alloy.

7. The method of claim 6 wherein the ratio of said first alloy to said second alloy is about 60/40.

8. The method of claim 6 wherein said exposed face comprises a cladding applied over at least a portion of said preform.

9. The method of claim 8 wherein said cladding comprises a cobalt-based alloy.

10. A method of repairing a seal land at a downstream or outlet end of a gas turbine transition piece extending between a combustor and a first stage nozzle, the seal land formed by one side wall of a U-shaped channel, the method comprising:
(a) removing material along substantially the entire seal land to provide a preform-receiving face;
(b) locating a repair preform along and engaged with said preform-receiving face;
(c) brazing the preform to said preform-receiving face; and
(d) finish machining an exposed face of the preform to specifications, thereby providing a repaired seal land within said U-shaped channel.

11. The method of claim 10 wherein said repair preform comprises a Co-based preform without melt point depressants and a braze tape with melt point depressants such that said braze tape bonds said Co-based repair preform to said preform receiving face.

12. The method of claim 10 wherein said repair preform is in tape form, comprising braze powder or a mixture of braze powder and superalloy powder.

13. The method of claim 10 wherein said repair preform comprises a powder mixture of a first nickel-chromium-cobalt alloy and a second nickel-chromium-boron alloy.

14. The method of claim 13 wherein the ratio of said first alloy to said second alloy is between about 80/20 to 20/80.

15. The method of claim 14 wherein said exposed face comprises a cobalt-based alloy cladding applied over at least a portion of said preform.

16. A gas turbine component comprising an end configuration with a seal land adapted to be engaged by a seal element;
said seal land comprised of a clad preform brazed to the component.

17. The component of claim 10 wherein said preform comprises a powder mixture of a first nickel-chromium-cobalt alloy and a second nickel-chromium-boron alloy.

18. The component of claim 14 wherein the ratio of said first alloy to said second alloy is about 60/40.

19. The component of claim 18 wherein said cladding comprises a cobalt-based alloy.

20. The component of claim 16 wherein said turbine component comprises a gas turbine transition piece, with said seal land located in a channel formed in a frame surrounding at an outlet end of said transition piece.
